(19) United States
(12) Patent Application Publication
(10) Pub. No.: US 2013/0167051 A1
(43) Pub. Date: Jun. 27, 2013

(54) METHOD AND SYSTEM FOR CUSTOMIZING A GRAPHIC USER INTERFACE OF A MANFUACTURING EXECUTION SYSTEM SCREEN

(71) Applicant: SIEMENS AKTIENGESELLSCHAFT, MUENCHEN (DE)

(72) Inventors: Simone Belotti, Genova (IT); Stefano Noferi, Genoa (IT)

(73) Assignee: SIEMENS AKTIENGESELLSCHAFT, MUENCHEN (DE)

(21) Appl. No.: 13/724,877

(22) Filed: Dec. 21, 2012

(30) Foreign Application Priority Data
Dec. 22, 2011 (EP) 11195274

(51) Int. Cl. G06F 3/048

(52) U.S. Cl. CPC G06F 3/048
USPC 715/763

(57) ABSTRACT

A method and a system are used to customize a user-interface of a screen of a MES application taking into account a customer requirement. The method includes providing within the MES application a page-screen containing a configurable graphic control, and providing a graphic configuration tool for enabling the configuration of the configurable graphic control of the page-screen. The method explores the page-screen so that a tree is presented in which each node represents a configurable graphic control. Further, a given node is selected and represents a given configurable graphic control and an associated custom area to be customized according to a given specific customer requirement. An ASP.net control is developed to meet the given specific customer requirement. The information of the ASP.net control is specified for linking it to the custom area of the configurable graphic control. Finally, the information for linking the custom area is stored.

### CROSS-REFERENCE TO RELATED APPLICATION

This application claims the priority, under 35 U.S.C. §119, of European application EP 11 195 274.3, filed Dec. 22, 2011; the prior application is herewith incorporated by reference in its entirety.

### BACKGROUND OF THE INVENTION

### Field of the Invention

The present invention relates to a method and to a system for customizing a graphic user interface (GUI) of a manufacturing execution system (MES) screen.

In the world of industrial automation of today, in order to increase competitiveness, manufacturing companies need to simultaneously reduce time-to-market, increase process visibility and production flexibility, optimize forecasting and scheduling, and reduce scrap, stock levels and downtimes; all while ensuring optimal quality and production efficiency across all global facilities.

Hence in order to meet these demanding goals, manufacturing companies require an integrated information technology (IT) infrastructure that helps them in coordinating production on a global scale and, if necessary, in real time. The manufacturing execution system (MES) is generally known as the IT layer that integrates the business systems (e.g. ERP) and production control systems.

Siemens Corporation offers a broad range of MES products, under its SIMATIC® product family.

As defined by the Manufacturing Enterprise Solutions Association (MESA International), the MES system “is a dynamic information system that drives effective execution of manufacturing operations”, by managing “production operations from point of order release into manufacturing to point of product delivery into finished goods” and by providing “mission critical information about production activities to others across the organization and supply chain via bi-directional communication.” The international standard for developing MES systems is commonly referred as ISA-95 or S95.

The functions that a MES system usually includes are resource allocation and status, dispatching production orders, data collection/acquisition, quality management, maintenance management, performance analysis, operations/detail scheduling, document control, labor management, process management and product tracking.

Thus, the goal of MES systems developed by software suppliers is to provide manufacturing companies (the customers) with tools for measuring and controlling production activities with the aim of boosting profitability, increasing productivity, improving quality and process performance to manufacturing plants.

As used herein, a software application is a set of software components developed by software developers to perform some useful actions within a MES system, e.g. monitoring values coming from plant process or controlling a plant device.

Typically, at engineering or configuration time, system engineers flexibly customize MES applications according to the specific manufacturing plant requirements.

Instead, at runtime, MES applications are utilized by end-users who may be plant operators or line responsible personnel.

MES systems are provided with front-end/client GUI applications which may be used by end-users to plan and control manufacturing activities.

MES GUI applications play a key role in bringing together process, quality and business information from various sources into one unified real-time view of the production status of the plant. In fact, MES GUI applications display to the end-user graphical screens which enable overview several parameters or scenarios of the plant activities.

Nowadays MES screens are mostly developed in the form of web-pages.

For example, with MES application suite SIMATIC IT, it is provided a client application builder which is composed of a set of modules allowing users to build customized GUI screen-pages.

Typically, software suppliers develop a MES software-product as a general purpose solution to meet several and different customer requirements. As a consequence to it, also the collections of MES screens, which are supplied with the MES product, are configured to be general purpose in order to be used in various different situations.

However, since customers require that MES products be customized for a specific project fitting their specific needs, also the GUIs of MES screens need to be customized in order to satisfy the customer requirements of the specific project. This customer need is a fundamental one since the end-users, at the customer site, interact with the MES product mainly through the GUI of the MES-screens.

Hence, some enhancement needs of MES customers have to be fulfilled on the specific single project, so that the effectiveness and the usability of the MES solution are improved.

A first enhancement need of MES customers regards the way data are inputted.

For example, some MES customers prefer to input particular data through a simple textbox and some other customers prefer to input the same data through a combo box that is already pre-filled with a set of values. Or in another simplified example, some customers wish to be notified that the data input in a field is wrong through an asterisk, other customers wish that the notification of occur a wrong field entry is provided via a change of the background color of the input field. In more advanced scenarios, MES end-user require that the gathering of the input data is done through external sources that need a custom interface, such as custom browsers or charts.

A second enhancement need of MES customers regards the customization of the master-detail view. In fact, MES screens are very often configured with a master-detail view: i.e. a grid or tree represents the main entity of the screen page and through the selection of a specific item; its details are shown.

Unfortunately, the details that each customer wants to see are often different and specific for a specific factory requirement. These details are usually related to a “master” entity in the page. Typically, the detail information can be view through a panel control or alternatively can be logically grouped through a tab control in different tab-panels.

There are three typical technical requirements that need to be met in screens configured with the master/details view.

A first typical technical requirement is to hide some details that were defined in the general purpose screen of the MES product.

A second technical requirement is to add some additional details that were not defined in the general purpose screen of the product.

A third technical requirement is to contextualize the added details so that they are aware of the original page and they behave accordingly.

Finally the added controls cannot work correctly without being aware of the original.

Hence it is seen that, since different MES customers have different requirements, different types of customizations are needed.

In the prior art, the customization problem of MES screen has been solved in two ways.

According to a first way, the source codes of the screens are delivered to the system engineers or to the system integrators that modify them according to the required customizations. This action has relevant cost impacts in terms of required time and efforts. In addition, another drawback is that the proprietary source code is exposed to third parties who often are not employees of the software developing company resulting in possible intellectual property problems.

According to a second way, the screens are developed from scratch by the software developers in order to meet the customer needs. A brand new web-page, in place of the original one, is to be created containing the required customizations. Unfortunately this second way has the drawback that it is not possible to develop general-purpose screens but only project-specific ones. The customization is customer-specific: a new modified version of the page is created. This action has a very high effort: effort of time for the analysis of the original page (the person who customizes the screen is not usually the same who created it); effort of time to modify the page; effort of time to test the page (also some solid regression testing is needed); effort to maintain a different version of the same page for different customers.

Unfortunately, in both known ways of customizing MES web-screens, the source code of the web-page has to be modified. This fact implies that the source code of the product-delivered screens needs to be completely tested again, with the relevant cost impacts in terms of time and efforts, also taking into account requirements on code maintenance and upgrades.

Moreover, with known methods of customizing MES web-screens, not only the development and customization efforts are increased but also the reusability of the delivered web-screens is reduced.

For example, in known methods of customizing web-screens in order to obtain one of the two above mentioned enhancements, i.e. the customization of the way of inputting data or of the master-detail view, an ASP.NET control (user or custom) is used, hosted on the web-page. However, unfortunately this customization is accomplished by adding and coding an ASP.NET control within the page by having access to the source code of the page with the above described drawbacks.

### SUMMARY OF THE INVENTION

It is therefore the aim of the present invention to overcome the above mentioned drawbacks, in particular by providing a method and a system for customizing a graphic user interface of a manufacturing execution system screen without modifying the source code of the web-screen.

With the foregoing and other objects in view there is provided, in accordance with the invention a method for customizing a user-interface of a screen of a general purpose manufacturing execution system (MES) software application in dependence on a specific customer requirement. The screen is a web-page more specifically a page-screen. The method includes the steps of:

providing within the general purpose MES software application at least one page-screen containing at least one configurable graphic control containing at least one custom area that can be customized;
providing a graphic configuration tool for enabling a configuration of the configurable graphic control of the user-interface of the page-screen in the at least one custom area;
exploring, at engineering time and through the graphic configuration tool, the page-screen so that, a tree is presented in which each node represents a configurable graphic control;
selecting, at engineering time, a given node representing a given configurable graphic control and at least one associated custom area to be customized according to a given specific customer requirement;
developing, at engineering time, an ASP.net control by writing software code to meet the given specific customer requirement;
specifying, at engineering time, through the graphic configuration tool, information of a developed additional ASP.net control for linking it to the associated custom area of the given configurable graphic control; and
storing, at engineering time, the information for linking the associated custom area of the given configurable graphic control on a web server or on a database.

Ideally the method is performed by at least one computer, processor or computing device having associate memory.

Furthermore, a computer program element can be provided, containing computer program code for performing steps according to the above mentioned method when loaded in a digital processor of a computing device.

Additionally, a computer program product stored on a computer usable medium can be provided, containing computer readable program code for causing a computing device to perform the mentioned method. In addition, a computer, processor or computing device can carry out the method.

Embodiments of the invention advantageously enable customizations by changing the page configuration through a dedicated tool so that the source code is not modified.

Embodiments of the invention conveniently lead to cost reductions, for the following reasons. Required efforts for customizing the web screens are reduced. Required maintenance of the software product is reduced. The approach is less error prone. No need of an exhaustive analysis and of knowledge of the original page design. No regression testing is needed for the web-page.

The customizations implemented through the proposed invention are not coded on the page so that in case of error they can be removed without affecting the original functionality of the original page supplied by the product.

Only a single version of the page exists. At most only different additional ASP.net controls are created, which can be advantageously reused in all screens and dynamically applied on demand. This leads to less maintenance cost.

According to the invention, the intellectual property of the original page is preserved. According to a first embodiment of the invention, which specifies a custom procedure for inputting input data in the user-interface of the page-screen, may advantageously allow switching through some pre-defined editors without writing a single line of code. Examples of pre-defined editors may include textbox with custom validation, combo-box with items dynamically defined, date pickers and others. Alternatively, a more complex extent of flexibility may be offered by allowing the use of a totally custom interface. In this case a piece of code containing the custom interface may be conveniently written and it will be dynamically loaded and it will replace the original one. This interface will consume the data gathered from the grid/detail and will provide to the grid/details the data input of the user. A person of average skill in the art easily appreciates that in order to write this piece of code an in-depth knowledge of the original page is not needed and that the piece of code can be easily shared all over the pages.

According to a second embodiment of the invention, which specifies a custom procedure for configuring a master/detail view in the user-interface of the screen-page in the user-interface of the page-screen, may enable to meet the three above mentioned technical requirements.

Through the configuration tool it is for example easy to configure which tab panel of the tab control needs to be shown.

Through the configuration tool it is for example possible to add new tab panels to the tab control. In addition, if desired, it is possible to configure the content of the added tab panel. The content is formed by custom controls that can contain any graphic elements. Hence, conveniently, information not initially conceived by the page developer can be added on demand. Moreover, these controls can be reused in multiple pages, saving effort and time of development.

Finally the added controls cannot work correctly without being aware of the original page. For this reason in the page there is created a repository containing context information for all the controls of the page. Each control gives information about its state: for example the grid gives information about the selected record, the filter control about the filter that it is applying, the toolbar about the button that is being clicked, and so on. Using this information, the added control knows the state of the page and they can act consequently: for example they can show information contextualized with the selected record of the grid.

All this can be accomplished without modifying the source code of the original page, but only adding ASP.NET controls that have been created during the development of a specific project for a specific customer: these controls can therefore contain all the customizations needed by the specific customer requirements.

Other features which are considered as characteristic for the invention are set forth in the appended claims.

Although the invention is illustrated and described herein as embodied in a method and system for customizing a graphic user interface of a manufacturing execution system screen, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is an illustration of a snapshot example taken from an input grid of a page-screen GUI of a first example embodiment according to the present invention;

FIG. 2 is an illustration of a snapshot example taken from a modified version of the input grid of FIG. 1 according to the first example embodiment of the present invention;

FIG. 3 is an illustration of a snapshot example of a GUI configuration editor of the GUI configuration tool, according to the first example embodiment of the present invention;

FIG. 4 is an illustration of a snapshot example taken from a master grid with a set of MES entities in a page-screen GUI, delivered with a general purpose MES software product, according to a second example embodiment of the present invention;

FIG. 5 is an illustration of a snapshot example of the tab-control containing a tab-panel called “Break Detail” with some detail information in form of records according to the second embodiment of the present invention; and

FIG. 6 is an illustration of a snapshot example of a GUI configuration editor of the GUI configuration tool, according to the second example embodiment of the present invention.

### DETAILED DESCRIPTION OF THE INVENTION

Two invention embodiments are described below. In both invention embodiments, a user-interface of a page-screen of a general purpose MES software application taking into account some specific customer requirements is customized.

Within the MES application, at least one page-screen containing at least one configurable graphic control is present, which contains at least one area that can be customized, herein called a custom area.

A graphic configuration tool enables the configuration of the configurable graphic control of the page-screen user-interface in at least one custom area.

At engineering time, through the configuration tool, the page-screen is explored so that, a tree is presented in which each node represents a configurable graphic control.

At engineering time, a given node is selected representing a given configurable graphic control and at least one associated custom area to be customized according to a given specific customer requirement.

At engineering time, an ASP.net control is developed by writing its software code in order to meet the given specific customer requirement.

At engineering time, through the configuration tool, the information of the developed additional ASP.net control is specified for linking it to the custom area of the configurable graphic control. Examples of such information may be the fully qualified name for custom control or the site relative path for a user control. Advantageously, upon request, parameters can be configured, at engineering time, in order to be sent, at run time, to the additional ASP.net control. Through the configuration tool it is possible to define for each field of a grid if the standard interface defined in the original page or a different one is to be used.

At engineering time, the information for linking the custom area of the given configurable graphic control is stored on the web server or on a database.

At run time, a user-interface of a screen of a general purpose MES software application may advantageously be displayed with the above described customizations.

### First Embodiment

### Data Input

According to a first embodiment of the present invention, through the configurable graphic control it is possible to specify a custom procedure for inputting input data in the user-interface of the screen-page. For example, the type of the configurable graphic control may be grid type or detail grid type.

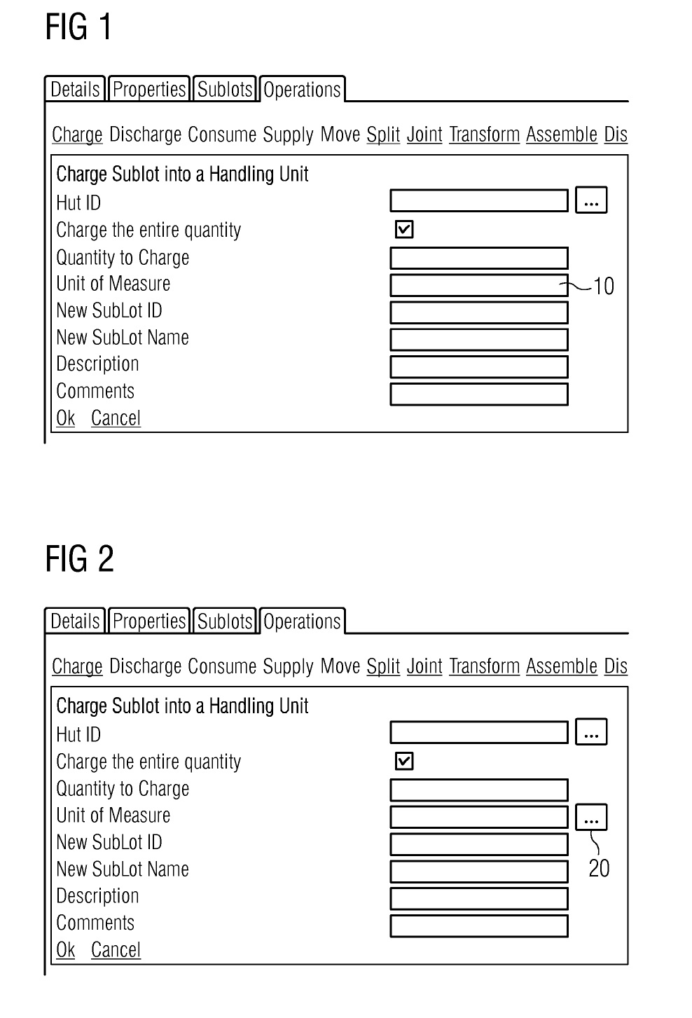

FIG. 1 is a snapshot example taken from an input grid of a page-screen GUI according to the first example embodiment of the present invention. For example, at run time, the end-users (e.g. line personnel) use the GUI shown in FIG. 1 to input the required input-fields (e.g. quantity to charge, unit of measure, etc.) of a given MES entity of operations for charging the sub-lot into a handling unit. The page-screen GUI example shown in FIG. 1 is a predefined page-screen GUI delivered to the customer with the general purpose MES software application.

Let us assume that the customer wishes to improve the usability of this predefined GUI by modifying the way data is inputted. Advantageously, with the first embodiment of the present invention, at engineering time, the system engineer is enabled to modify, within the predefined graphic screen in a custom area, the editor for data input, without accessing the source code.

For example, in the snapshot of input grid of FIG. 1, at the field “Unit of Measure” 10, with the general purpose product, it is originally foreseen the use of a simple text-box where the user has to enter with a free hand the desired unit of measure. The system engineer wishes, instead, to improve the GUI by supplying, for example, a browser presenting a set of selectable units of measure.

The objective of the system engineer is to have a customized input form as the one shown in FIG. 2. FIG. 2 is a snapshot example taken from a modified version of the input grid of FIG. 1, according to the first example embodiment of the present invention. In FIG. 2 the entry “Unit of Measure” of the input grid has been customized according to the requirement of the system engineer so that, at run-time, by clicking the button 20 on the right of the entry “Unit of Measure”, a browser of selectable options is displayed.

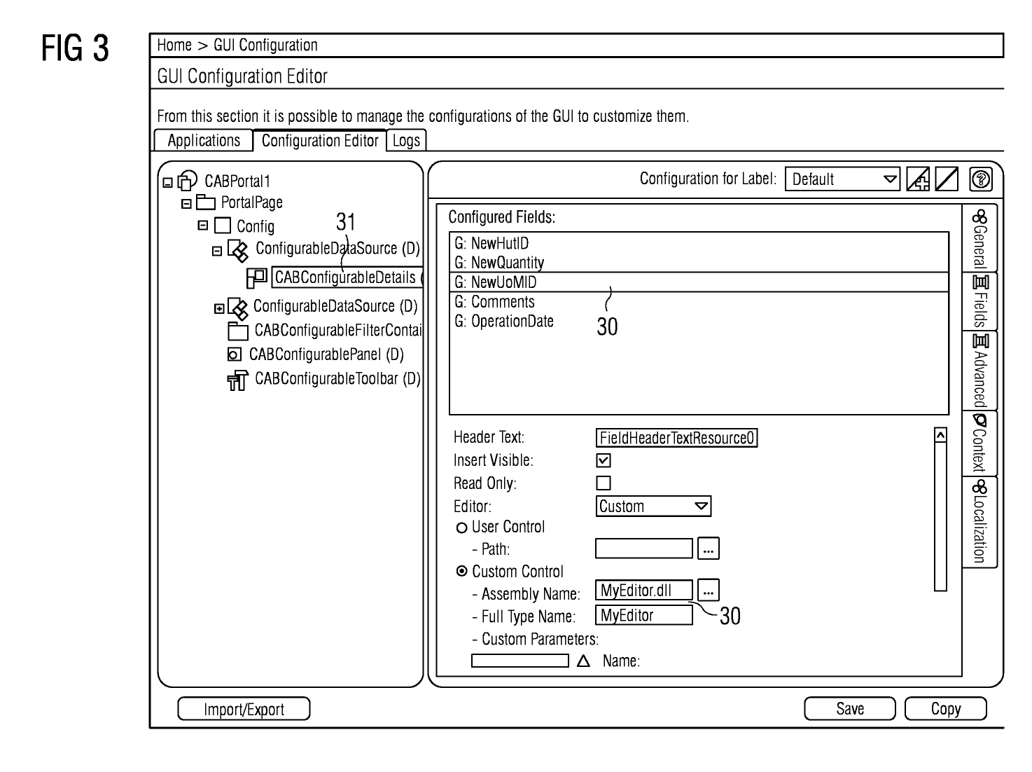

The customization shown in FIG. 2 is implemented, according to the present invention, through a GUI configuration tool. FIG. 3 shows a snapshot example of a GUI configuration editor of the GUI configuration tool, according to the first example embodiment of the present invention.

The configuration tool explores the website that hosts the page and presents on a tree the point of configuration of the system. Thus, the configuration tool may show for each page-screen of the website that compose the MES application a tree in which each node is a configurable graphic control that can be configured by the configuration tool.

For this specific example, as shown in FIG. 3, from the configuration tool it is possible to select a specific configurable operation input grid, e.g. “CabConfigurableDetails” 31, and specify that for the “Unit of Measure” field it is desired to use as input editor a specific ASP.net control developed by the system engineer, in this case a custom control. With a custom editor 30, to the newly developed ASP.net custom control “NewUoMID” it is assigned the assembly name myEditor.dll.

### Second Embodiment

### Master-Detail View

According to a second embodiment of the present invention, through the configurable graphic control may be advantageously possible to specify a custom procedure for adding detail information to a master/detail view in the user-interface of the screen-page. For example, the type of the configurable graphic control may be a tab type or a panel type.

In this embodiment, a communication mechanism placed in the page-screen is preferably provided to allow at run time exchanging information between a configurable graphic control already present in the page-screen and the developed ASP.net control.

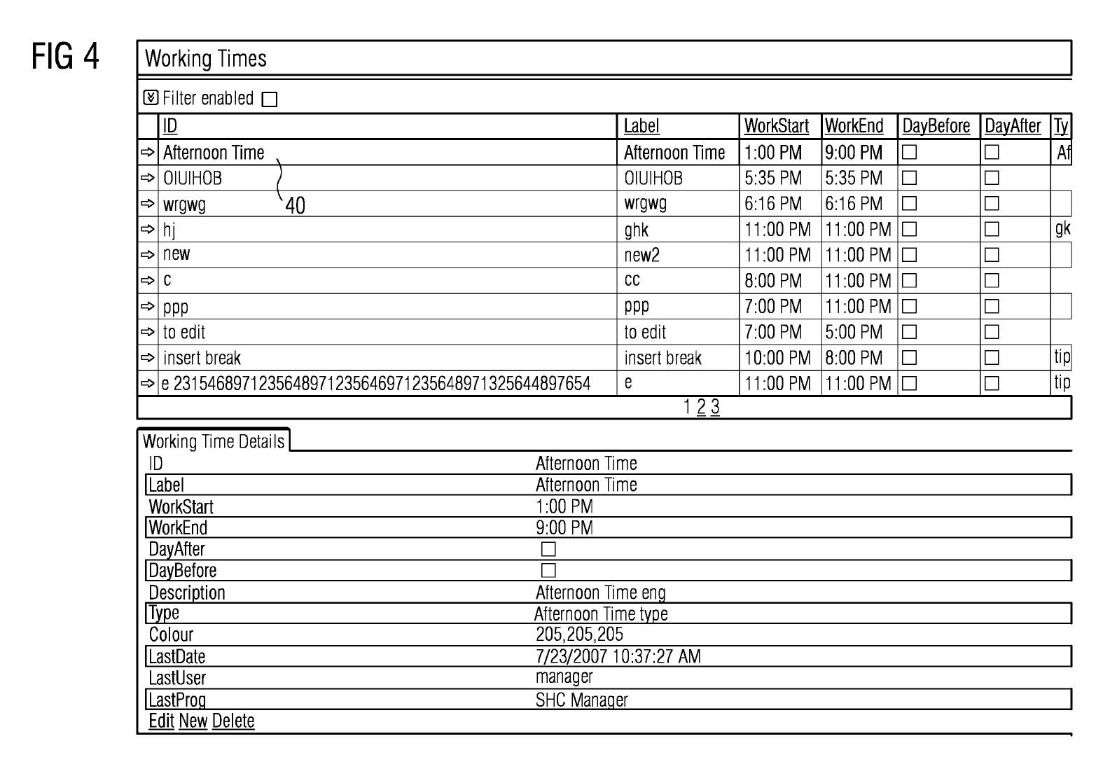

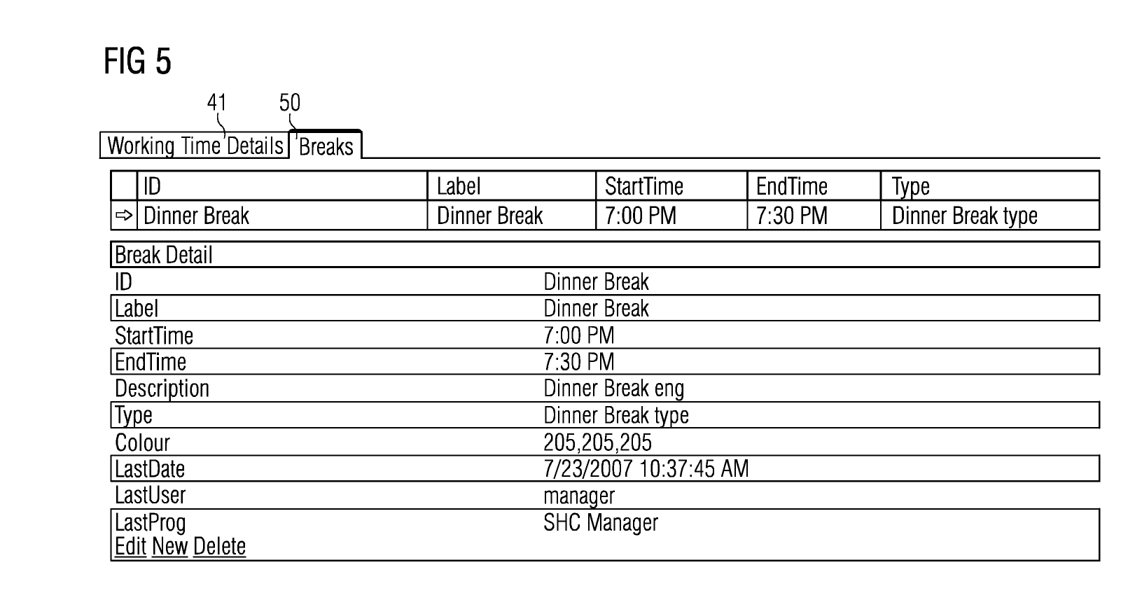

FIG. 4 is a snapshot example taken from a master grid with a set of MES entities in a page-screen GUI, delivered with a general purpose MES software product, according to a second example embodiment of the present invention.

Let us assume that the customer wishes to improve the usability of this predefined page-screen by adding to it in a custom area one or more control that extends the original page, containing for instance some details about a selected entry on a master grid.

As shown in the snapshot of the master grid of FIG. 4, for the entity “Afternoon Time” 40, it is foreseen, upon selection, a detailing tab-panel called “Working Time Details” 41.

Let us assume that the system engineer wishes to improve the user interface by adding in a custom area a custom control containing for instance some details about a selected entry on a master grid. For example, in this specific example, the system engineer wishes to add a new detailing tab-panel providing other detailing information about the selected entry on the master grid, e.g. by adding a tab-panel called “Breaks” 50 containing break details on the same selected entry “Afternoon Time” 40 of the master grid.

FIG. 5 shows a snapshot example of the tab-control containing a tab-panel called “Breaks” with some break detail information in form of records according to the second embodiment of the present invention.

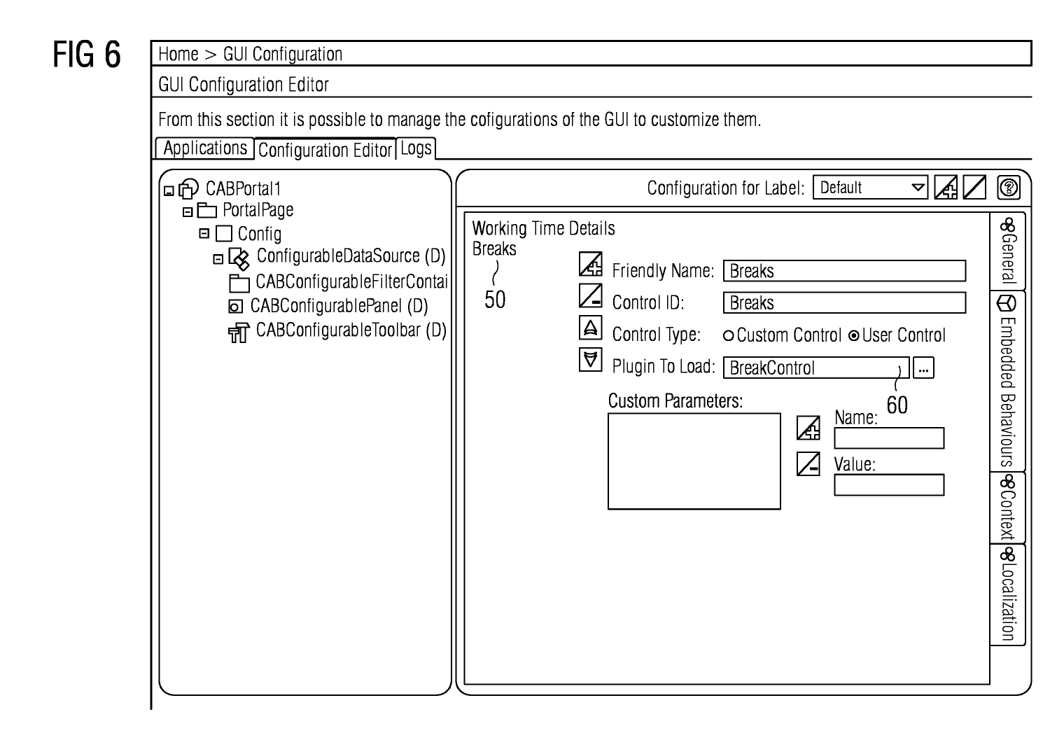

The customization shown in FIG. 5 is implemented, according to the present invention, through a GUI configuration tool. FIG. 6 shows a snapshot example of a GUI configuration editor of the GUI configuration tool, according to the second example embodiment of the present invention.

The configuration tool explores the website that hosts the page and presents on a tree the point of configuration of the system.

For this specific example, as shown in FIG. 6, from the configuration tool it is possible to add, to the configurable graphic tab control, a tab panel called “Breaks” 50 and specify to load a specific ASP.net control developed by the system engineer, in this case a user control called “BreakControl” 60. With the custom editor shown in FIG. 6, to the ASP.net user control 60 it is assigned the Friendly Name and Control ID “Breaks”.

In addition to the embodiments of the present invention described above, the person of average skill in the art will be able to arrive at a variety of other arrangements and steps which, if not explicitly described in this document, nevertheless fall within the scope of the appended claims. For example, with embodiments of the present invention, it is possible to modify the master view in the master-detail view.

### LIST OF USED ACRONYMS

GUI Graphical User Interface
IT Information Technology
MES Manufacturing Execution System

1. A method for customizing a user-interface of a screen of a general purpose manufacturing execution system (MES) software application in dependence on a specific customer requirement, the screen being a web-page more specifically a page-screen, which method comprises the steps of:
providing within the general purpose MES software application at least one page-screen containing at least one configurable graphic control containing at least one custom area that can be customized;
providing a graphic configuration tool for enabling a configuration of the configurable graphic control of the user-interface of the page-screen in the at least one custom area;
exploring, at engineering time and through the graphic configuration tool, the page-screen so that, a tree is presented in which each node represents a configurable graphic control;
selecting, at engineering time, a given node representing a given configurable graphic control and at least one associated custom area to be customized according to a given specific customer requirement;
developing, at engineering time, an ASP.net control by writing software code to meet the given specific customer requirement;
specifying, at engineering time, through the graphic configuration tool, information of a developed additional ASP.net control for linking it to the associated custom area of the given configurable graphic control; and
storing, at engineering time, the information for linking the associated custom area of the given configurable graphic control on a web server or on a database.

2. The method according to claim 1, wherein the given configurable graphic control specifies a custom procedure for inputting input data in the user-interface of the page-screen.

3. The method according to claim 2, which further comprises selecting a type of the given configurable graphic control from the group consisting of a grid type and a detail grid type.

4. The method according to claim 1, wherein through the configurable graphic control, a custom procedure is specified for adding detail information to a master/detail view in the user-interface of the page-screen.

5. The method according to claim 4, which further comprises selecting the type of the given configurable graphic control from the group consisting of a tab control type and a panel control type.

6. The method according to claim 4, which further comprises providing a communication mechanism placed in the page-screen to allow at run time exchanging information between the given configurable graphic control already present in the page-screen and the ASP.net control.

7. The method according to claim 1, which further comprises selecting the ASP.net control from the group consisting of a custom control and a user control.

8. A method, which comprises the step of:
displaying, at run time, a user-interface of a screen of a general purpose MES software application customized according to claim 1.

9. A non-transitory computer-readable medium having computer-executable instructions for performing a method for customizing a user-interface of a screen of a general purpose manufacturing execution system (MES) software application in dependence on a specific customer requirement, the screen being a web-page more specifically a page-screen, which method comprises the steps of:
providing within the general purpose MES software application at least one page-screen containing at least one configurable graphic control containing at least one custom area that can be customized;
providing a graphic configuration tool for enabling a configuration of the configurable graphic control of the user interface of the page-screen in the at least one custom area;
exploring, at engineering time and through the graphic configuration tool, the page-screen so that, a tree is presented in which each node represents a configurable graphic control;
selecting, at engineering time, a given node representing a given configurable graphic control and at least one associated custom area to be customized according to a given specific customer requirement;
developing, at engineering time, an ASP.net control by writing software code to meet the given specific customer requirement;
specifying, at engineering time, through the graphic configuration tool, information of a developed additional ASP.net control for linking it to the associated custom area of the given configurable graphic control; and
storing, at engineering time, the information for linking the associated custom area of the given configurable graphic control on a web server or on a database.

10. A system, comprising:
means programmed for performing a method for customizing a user-interface of a screen of a general purpose manufacturing execution system (MES) software application in dependence on a specific customer requirement, the screen being a web-page more specifically a page-screen, said means programmed to:
provide within the general purpose MES software application at least one page-screen containing at least one configurable graphic control containing at least one custom area that can be customized;
provide a graphic configuration tool for enabling a configuration of the configurable graphic control of the user interface of the page-screen in the at least one custom area;
explore, at engineering time and through the graphic configuration tool, the page-screen so that, a tree is presented in which each node represents a configurable graphic control;
select, at engineering time, a given node representing a given configurable graphic control and at least one associated custom area to be customized according to a given specific customer requirement;
develop, at engineering time, an ASP.net control by writing software code to meet the given specific customer requirement;
specify, at engineering time, through the graphic configuration tool, information of a developed additional ASP.net control for linking it to the associated custom area of the given configurable graphic control; and
store, at engineering time, the information for linking the custom area of the given configurable graphic control on a web server or on a database.

11. The system according to claim 10, wherein said means is selected from the group consisting of at least one of a computer, a processor and a computing device.
